(19) United States
(12) Patent Application Publication
(10) Pub. No.: US 2011/0291984 A1
(43) Pub. Date: Dec. 1, 2011

(54) CAPACITIVE TOUCH PANEL AND GHOST POINT DETERMINATION METHOD

(75) Inventors: Chih-Chao Chang, Taipei City (TW); Chao-Yong Hsu, Changhua County (TW); Shin-Chung Huang, Taipei County (TW); Yi-Nan Chu, Changhua County (TW)

(73) Assignee: CHUNGHWA PICTURE TUBES, LTD., Taoyuan (TW)

(21) Appl. No.: 12/853,311

(22) Filed: Aug. 10, 2010

(30) Foreign Application Priority Data
May 28, 2010 (TW) 99117182

(51) Int. Cl. G06F 3/045

(52) U.S. Cl. 345/174

(57) ABSTRACT

A capacitive touch panel and a ghost point determination method are provided. The capacitive touch panel includes a touch sensing plate and a touch sensing module. The touch sensing plate includes a plurality of sensing units. The sensing units are disposed along a first direction and a second direction to from an array. Capacitance values of the sensing units are decreased gradually along the first direction. The touch sensing module is coupled to the touch sensing plate for sensing at least two real touch points.

### CROSS-REFERENCE TO RELATED APPLICATION

This application claims the priority benefit of Taiwan application serial no. 99117182, filed on May 28, 2010. The entirety of the above-mentioned patent application is hereby incorporated by reference herein and made a part of this specification.

### BACKGROUND OF THE INVENTION

1. Field of the Invention

The invention relates to a ghost point determination technique, and particularly relates to a ghost point determination technique of a capacitive touch panel.

2. Description of Related Art

Information technologies (ITs), wireless mobile communications, and information home appliances have been rapidly developed and widely applied. To meet current demands on portable, compact, and user-friendly IT products, touch panels have been introduced as input devices in replacement of conventional input devices, such as keyboards or mice.

Currently, the touch panel can be mainly divided into resistive type, capacitive type, acoustic type, optical type, etc. It is noted that the capacitive touch panel of the convention technique has an unsolved problem of ghost point when sensing a two point touch.

FIG. 1 is a schematic view showing the ghost points on a conventional capacitive touch point. Referring to FIG. 1, when two real touch points are P1 and P4, corresponding ghost points, i.e. P2 and P3, also occur at the other diagonal corners of the real touch points because the coordinate signals of multi-touch sensing fails to be correctly determined. On the contrary, when the real touch points are P2 and P3, the capacitive touch panel similarly determines the touch points P1˜P4 which includes the real touch points P2 and P3 and the ghost points P1 and P4. Therefore, two real touch points can not be determined from the ghost points P1˜P4 by the capacitive touch panel.

### SUMMARY OF THE INVENTION

The invention provides a capacitive touch panel capable of improving the touch point determination problem of the system.

The invention provides a ghost point determination method so that two real touch points can be obtained from four system-determined touch points by the system.

The invention provides a capacitive touch panel including a touch sensing plate and a touch sensing module. The touch sensing plate includes a plurality of sensing units. The sensing units are arranged along a first direction and a second direction to form an array. The sensing units are capacitive type. Capacitance values of the sensing units along the first direction are decreased gradually. The touch sensing module is coupled to the touch sensing plate for sensing at least two real touch points.

According to one embodiment of the invention, the capacitance values of the sensing units along the second direction are consistent.

According to one embodiment of the invention, when four system-determined touch points are sensed, the sensing units are sequentially sensed along the second direction to sequentially sense a first duty cycle and a second duty cycle. Next, two real touch points are obtained from the four system-determined touch points according to the values of the first duty cycle and the second duty cycle.

According to one embodiment of the invention, the touch sensing module includes a plurality of pulse width modulation (PWM) signal generators and a touch point determination module. The PWM signal generators are respectively coupled to the sensing units. It is assumed that the two real touch points are located on a first sensing unit and a second sensing unit of the sensing units, the first sensing unit and the second sensing unit are respectively corresponding to a first PWM signal generator and a second PWM signal generator of the PWM signal generators, and the first PWM signal generator and the second PWM signal generator are sequentially arranged along the second direction. Under such circumstance, the first PWM signal generator outputs a corresponding first PWM signal and then the second PWM signal generator outputs a corresponding second PWM signal. Duty cycles of the first PWM signal and the second PWM signal are determined according to capacitance values of the first sensing unit and the second sensing unit. The touch point determination module is coupled to the PWM signal generators, sequentially receives the first PWM signal and the second PWM signal, and obtains two real touch points from the four system-determined touch points according to the values of the duty cycles of the first PWM signal and the second PWM signal.

According to one embodiment of the invention, the four system-determined touch points form a rectangle. The four system-determined touch points are respectively a first system-determined touch point, a second system-determined touch point, a third system-determined touch point, and a fourth system-determined touch point. The first system-determined touch point and the fourth system-determined touch point are located at corners of a diagonal in respect of the rectangle. The second system-determined touch point and the third system-determined touch point are located at corners of the other diagonal in respect of the rectangle. It is assumed that the first system-determined touch point is getting closer to the fourth system-determined touch point by moving along the first direction or the second direction. When the first duty cycle is larger than the second duty cycle, the first system-determined touch point and the fourth system-determined touch point are the two real touch points. When the first duty cycle is smaller than the second duty cycle, the second system-determined touch point and the third system-determined touch point are the two real touch points.

According to one embodiment of the invention, the first direction and the second direction are perpendicular with each other. In other words, the first direction is defined as a horizontal axis and the second direction is defined as a vertical direction. Alternately, the first direction is defined as a vertical axis and the second direction is defined as a horizontal direction.

According to one embodiment of the invention, the capacitance values of the sensing units located at the two real touch point are increased.

In another aspect, the invention provides a ghost point determination method suitable for being applied in a capacitive touch panel. The capacitive touch panel includes a touch sensing plate and a touch sensing module. The touch sensing plate includes a plurality of sensing units. The sensing units are arranged along a first direction and a second direction to form an array. The first direction is perpendicular to the second direction. The sensing units are capacitive type. Capacitance values of the sensing units are decreased gradually along the first direction. The ghost point determination method includes: when four system-determined touch points are sensing, sequentially sensing the sensing units along the second direction to sequentially sense a first duty cycle and a second duty cycle. In addition, two real touch points are obtained from the four system-determined touch points according to the first duty cycle and the second duty cycle.

In view of the above, the capacitance values of the sensing units are decreased gradually along the first direction. When four system-determined touch points are sensed, the sensing units are sensed along the second direction perpendicular to the first direction to sequentially obtain a first duty cycle and a second duty cycle. Next, two real touch points can be determined from the four system-determined touch points according to the first duty cycle and the second duty cycle.

To make the above features and advantages of the present invention more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view showing the ghost points on a conventional capacitive touch point.

FIG. 2A and FIG. 2B are schematic views of a capacitive touch panel according to an embodiment of the invention.

FIG. 3 is a flowchart of a ghost point determination method according to an embodiment of the invention.

FIG. 4 is a schematic view of a capacitive touch panel according to another embodiment of the invention.

FIG. 5A and FIG. 5B are schematic views of a capacitive touch panel according to an embodiment of the invention.

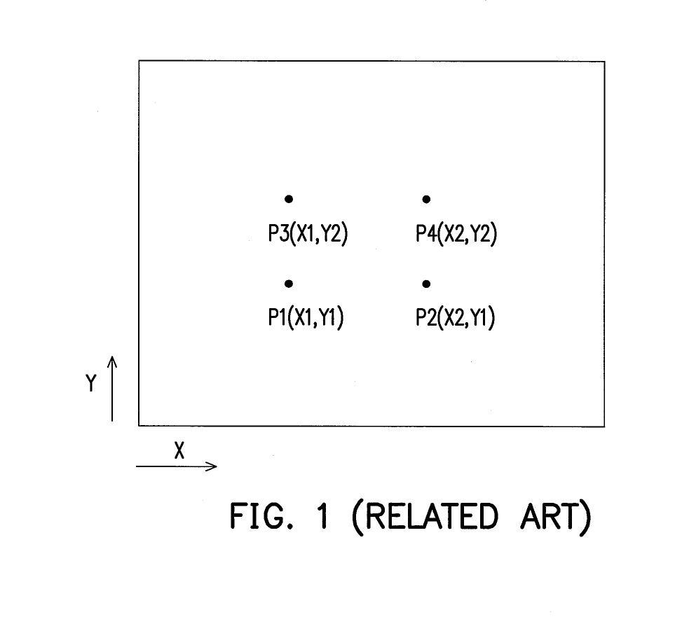

### DESCRIPTION OF EMBODIMENTS

The conventional capacitive touch panel has the ghost point problem.

On the contrary, a plurality of sensing units are disposed in a capacitive touch panel of the embodiments according to the invention. The sensing units are arranged along a first direction and a second direction to form an array. The first direction is perpendicular to the second direction. Capacitance values of the sensing units are decreased gradually along the first direction. When four system-determined touch points occurred, the sensing units are sensed along the second direction to sequentially obtain a first duty cycle and a second duty cycle. Next, two real touch points can be determined from the four system-determined touch points according to the first duty cycle and the second duty cycle. Descriptions of the invention are given below with reference to the embodiments illustrated in accompanying drawings, wherein same or similar steps are denoted with same reference numerals.

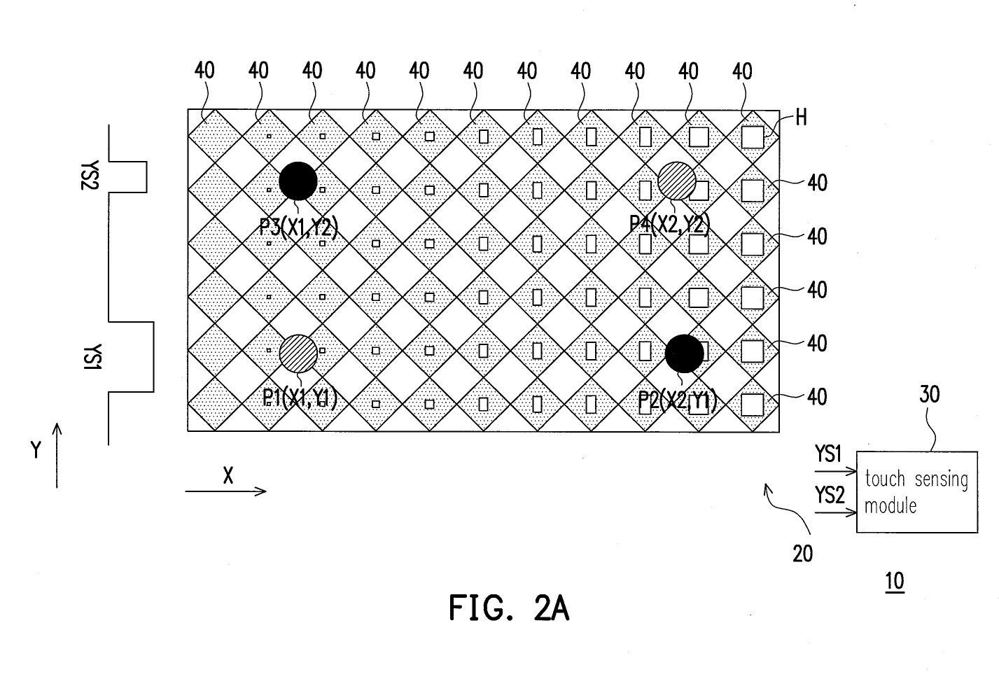

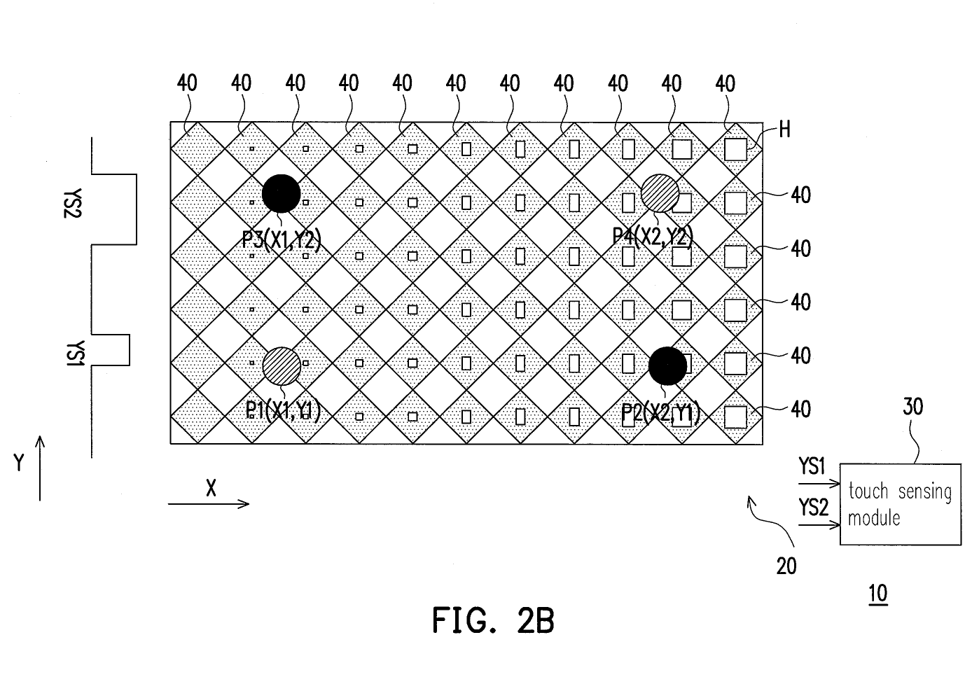

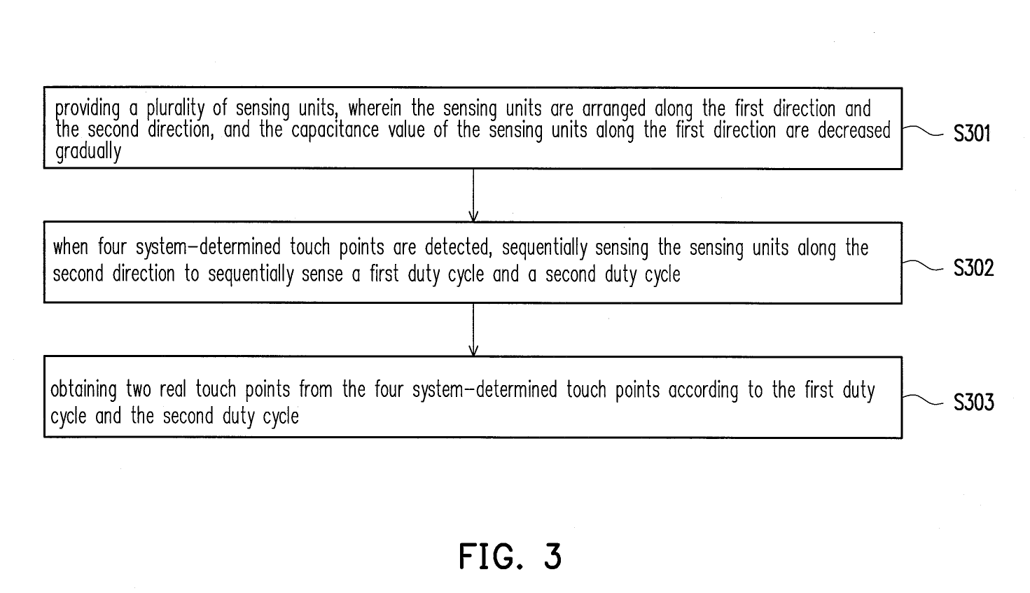

FIG. 2A and FIG. 2B are schematic views of a capacitive touch panel according to an embodiment of the invention. FIG. 3 is a flowchart of a ghost point determination method according to an embodiment of the invention. Referring to FIG. 2A, FIG. 2B, and FIG. 3 together, a capacitive touch panel 10 includes a touch sensing plate 20 and a touch sensing module 30. The touch sensing plate 20 includes a plurality of sensing units 40. In the present embodiment, the sensing units 40 are capacitive type. The touch sensing module 30 is coupled to the touch sensing plate 20.

Firstly, the plurality of sensing units 40 are provided in the step S301. The sensing units 40 are arranged along a direction X and a direction Y to form an array. The direction X is perpendicular to the direction Y. The sensing units 40 are capacitive type. According to the present embodiment, capacitance values of the sensing units 40 are decreased along the direction X and capacitance values of the sensing units 40 are consistent along the direction Y. It is noted that the capacitance values of the sensing units 40 are proportional to areas of the sensing pads thereof. The sensing units having different capacitance values can be achieved by changing the areas of the sensing pads of the sensing units in the present embodiment. For example, hollows H can be formed on the sensing units 40. The larger the hollows H, the smaller the areas of the sensing pads and the smaller the capacitance values of the sensing units 40. On the contrary, the smaller the hollows H, the larger the areas of the sensing pads and the larger the capacitance values of the sensing units 40.

Referring to FIG. 2A and FIG. 2B, it is assumed that the four system-determined touch points are respectively system-determined touch points P1(X1,Y1), P2(X2,Y1), P3 (X1,Y2), and P4(X2,Y2). The system-determined touch points P1˜P4 form a rectangle. The system-determined touch points P1 and P4 are located at corners of a diagonal in respect of the rectangle. The system-determined touch points P2 and P3 are located at corners of the other diagonal in respect of the rectangle.

Next, in the step S302, when four system-determined touch points P1˜P4 are sensed, the sensing units 40 are sequentially sensed along the direction Y by the touch sensing module 30 to sequentially detect a duty cycle YS1 and a duty cycle YS2 (as shown in FIG. 2A and FIG. 2B. It is noted that the duty cycle YS1 represents the information of the system-determined touch point P1(X1,Y1) or P2(X2,Y1). The duty cycle YS2 represents the information of the system-determined touch point P3(X1,Y2) or P4(X2,Y2).

It should be worthy to note that the occurrence of four system-determined touch points means merely two circumstances. One is that the two real touch points are P1 and P4, wherein the capacitance value of the sensing unit 40 corresponding to the system-determined touch point P1 is larger than the capacitance value of the sensing unit 40 corresponding to the system-determined touch point P4. The other is that the two real touch points are P2 and P3, wherein the capacitance value of the sensing unit 40 corresponding to the system-determined touch t point P2 is smaller than the capacitance value of the sensing unit 40 corresponding to the system-determined touch point P3. It is noted that the increase of the capacitance values of the sensing units 40 generated at the real touch points is omitted herein.

Accordingly, the step S303 is sequentially performed. Two real touch points are obtained from the four system-determined touch points by the touch sensing module 30 according to the duty cycle YS1 and the duty cycle YS2. If the duty cycle YS1 is larger than the duty cycle YS2, the system-determined touch points P1 and P4 are the real touch points (as shown in FIG. 2A) and the system-determined touch points P2 and P3 are the ghost points. On the contrary, if the duty cycle YS1 is smaller than the duty cycle YS2, the system-determined touch points P2 and P3 are the real touch points (as shown in FIG. 2B) and the system-determined touch points P1 and P4 are the ghost points. Accordingly, the two real touch points are obtained from the four system-determined touch points.

It is noted that although the above embodiment has disclosed a possible type of a capacitive touch panel and a ghost point determination method, it is common sense to persons skilled in the art that different manufacturers may develop different designs of the capacitive touch panel and the ghost point determination method, and the invention should not be limited to this type only. In other words, it conforms to the spirit of the invention as long as the capacitance values of the plurality of sensing units are decreased gradually along the first direction and the sensing units are detected sequentially along the second direction perpendicular to the first direction. The following further provides some other embodiments to allow persons having ordinary knowledge in the art to understand the spirit of the invention and implement the invention.

In the above embodiment, the sensing units having different capacitance values are achieved by the formation of the hollows, which is merely an embodiment and the invention is not limited hereby. Persons skilled in the art are able to accomplish the sensing units having different capacitance values by other methods based on the actual demands. For example, the sensing units having different capacitance values can also be achieved by changing the distances between the sensing pads.

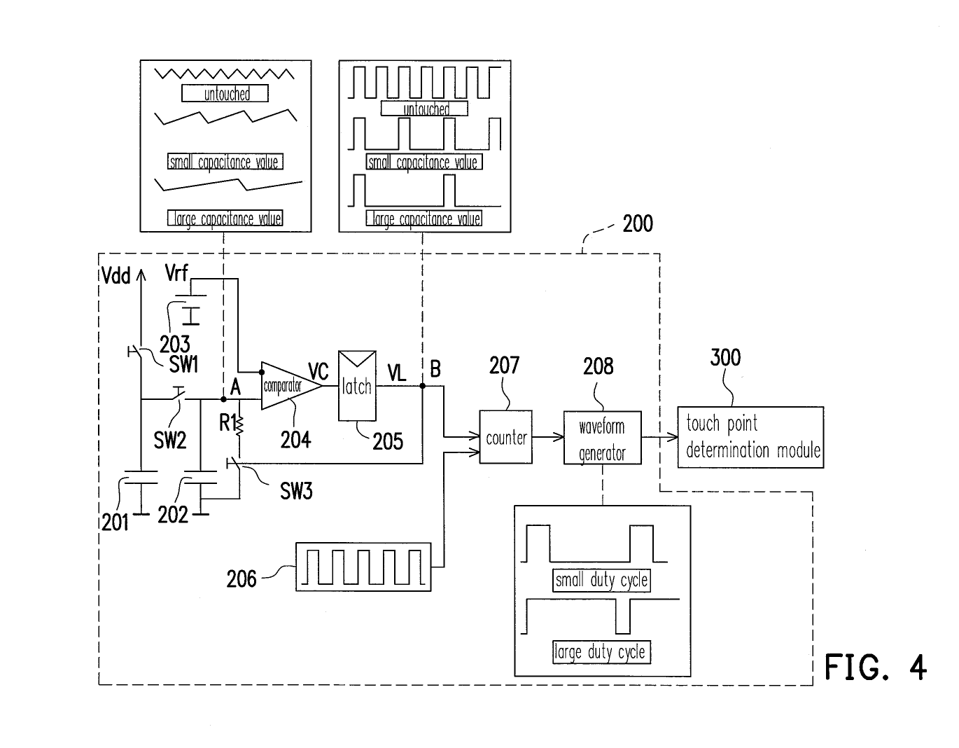

In the above embodiment, the two real touch points are obtained from the four system-determined touch points according to the values of the duty cycles YS1 and YS2, which is merely an embodiment and the invention is not limited hereby. Persons skilled in the art may transform the capacitance values into other electric signals to indirectly determine the capacitance value according to requirements. For instance, FIG. 4 is a schematic view of a capacitive touch panel according to another embodiment of the invention. Referring to FIG. 2A, FIG. 2B, and FIG. 4 together, the touch sensing module 30 includes a plurality of pulse width modulation (PWM) signal generators 200 and a touch point determination module 300. The PWM signal generators 200 are respectively coupled to the corresponding sensing units 40. The PWM signal generator 200 is capable of generating a PWM signal according to the capacitance value of the corresponding sensing unit 40, wherein a duty cycle of the PWM signal is determined according to the capacitance value of the corresponding sensing unit 40.

Specifically, the PWM signal generator 200 can include an outer capacitor 201, an inner capacitor 202, a reference voltage generator 203, a comparator 204, a latch 205, a high frequency clock generator 206, a counter 207, a waveform generator 208, switches SW1˜SW3, and a resistor R1. The switches SW1˜SW3 are used to control the charge or the discharge of the outer capacitor 201 and the inner capacitor 202, wherein Vdd is a constant voltage. The whole capacitance value of the outer capacitor 201 and the inner capacitor 202 is determined by the capacitance value of the sensing unit 40. The larger the capacitance value of the sensing unit 40 is, the larger the whole capacitance value of the outer capacitor 201 and the inner capacitor 202 is. On the contrary, the smaller the capacitance value of the sensing unit 40 is, the smaller the whole capacitance value of the outer capacitor 201 and the inner capacitor 202 is. The larger the whole capacitance value of the outer capacitor 201 and the inner capacitor 202 is, the slower the charge rate or the discharge rate thereof is. The smaller the whole capacitance value of the outer capacitor 201 and the inner capacitor 202 is, the faster the charge rate or the discharge rate thereof is. The reference voltage generator 203 is capable of providing a reference voltage Vrf to the comparator 204. The comparator 204 is capable of comparing the voltage of terminal A and the reference voltage Vrf and outputting a comparison result VC to the latch 205.

The latch 205 is capable of latching the comparison result VC and outputting a latch result VL to the counter 207 and the switch SW3. The switch SW3 is turned-on or turned-off based on the latch result VL. The high frequency clock generator 206 is capable of providing a high frequency clock signal to the counter 207. The counter 207 is capable of performing a counting action according to the latch result VL and the high frequency clock signal, and outputting the counting result to the waveform generator 208. The waveform generator 208 is capable of generating a PWM signal according to the counting result, wherein the duty cycle of the PWM signal is determined by the counting result.

In an untouched status, high frequency signals are presented at the terminals A and B. When a touch point is generated at the sensing unit 40 having larger capacitance value, the charge rate or the discharge rate of the outer capacitor 201 and the inner capacitor 202 is slow so that the signal frequency at the terminals A and B is smaller. The waveform generator 208 thus generates the PWM signal having larger duty cycle to the touch point determination module 300. When a touch point is generated at the sensing unit 40 having smaller capacitance value, the charge rate or the discharge rate of the outer capacitor 201 and the inner capacitor 202 is fast so that the signal frequency at the terminals A and B is larger. The waveform generator 208 thus generates the PWM signal having smaller duty cycle to the touch point determination module 300.

The touch point determination module 300 coupled to the abovementioned PWM signal generators 200 sequentially receives a first PWM signal and a second PWM signal along the scanning direction (the direction Y in the present embodiment). In the present embodiment, the duty cycle of the first PWM signal is correlative to the value of the duty cycle YS1. The duty cycle of the second PWM signal is correlative to the value of the duty cycle YS2. The two real touch points can be obtained from the four system-determined touch points P1˜P4 by the touch point determination module 300 according to the duty cycles of the first PWM signal and the second PWM signal. The method for obtaining the real touch points can be referred to the aforesaid embodiment, and is reiterated herein.

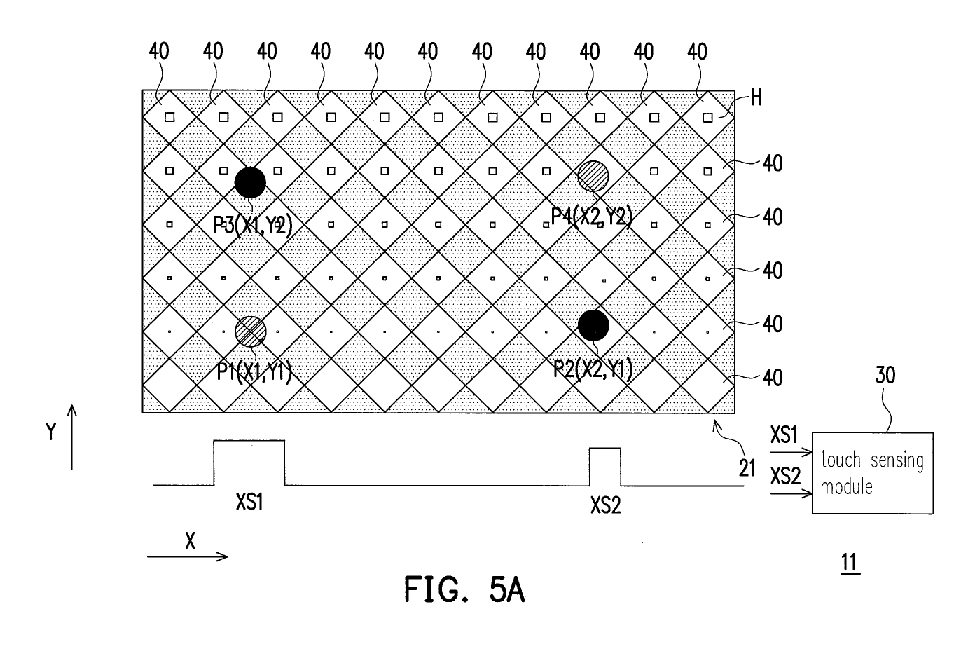

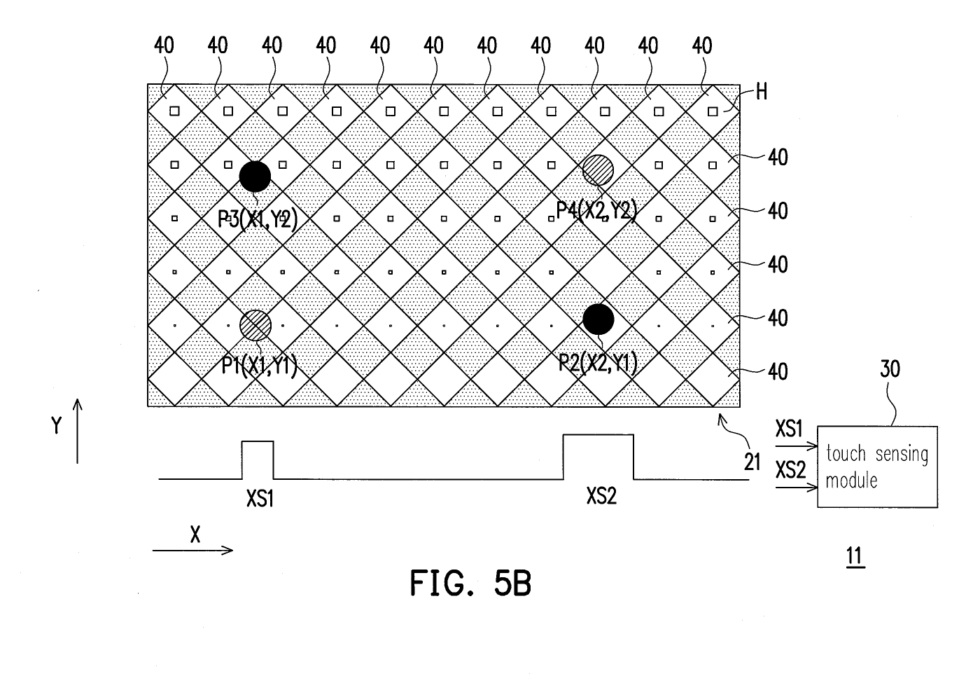

In addition, in the above embodiment depicted in FIGS. 2A and 2B, the capacitance values of the sensing units 40 are decreased gradually along the direction X, which is merely an embodiment and the invention is not limited hereby. For example, FIG. 5A and FIG. 5B are schematic views of a capacitive touch panel according to an embodiment of the invention. FIG. 5A and FIG. 5B are similar to FIG. 2A and FIG. 2B. The difference lies in that the capacitance values of the sensing units 40 are gradually decreased along the direction Y in the touch sensing plate 21 of the capacitive touch panel 11 depicted in FIG. 5A and FIG. 5B.

When four system-determined touch points P1˜P4 are sensed, the sensing units 40 are sequentially sensed along the direction X by the touch sensing module 30 to sequentially detect a duty cycle XS1 and a duty cycle XS2. If the duty cycle XS1 is larger than the duty cycle XS2, the system-determined touch points P1 and P4 are the real touch points (as shown in FIG. 5A) and the system-determined touch points P2 and P3 are the ghost points. On the contrary, if the duty cycle XS1 is smaller than the duty cycle XS2, the system-determined touch points P2 and P3 are the real touch points (as shown in FIG. 5B) and the system-determined touch points P1 and P4 are the ghost points. Accordingly, the two real touch points are obtained from the four system-determined touch points.

It should be illustrated that the direction X points to the right side from the left side and the direction Y points to the upper side from the bottom side in FIG. 2A, FIG. 2B, FIG. 5A, and FIG. 5B, for example, but the invention is not limited thereto. Persons skilled in the art may understand that when the direction X is changed to point to the left side from the right side and the direction Y is changed to point to the bottom side from the upper side in the above embodiments, the two real touch points can still be obtained from the four ghost points as long as the determination method of the touch sensing module 30 is properly adjusted.

In summary, the sensing units are arranged along a first direction and a second direction perpendicular to the first direction to form an array in the invention. Capacitance values of the sensing units are decreased gradually along the first direction. When four system-determined touch points are detected, the sensing units are sensed along the second direction to sequentially obtain a first duty cycle and a second duty cycle. Next, two real touch points can be determined from the four system-determined touch points according to the first duty cycle and the second duty cycle.

Although the present invention has been described with reference to the above embodiments, it will be apparent to one of the ordinary skill in the art that modifications to the described embodiments may be made without departing from the spirit of the invention. Accordingly, the scope of the invention is defined by the attached claims not by the above detailed descriptions.

What is claimed is:

1. A capacitive touch panel, comprising:
a touch sensing plate comprising a plurality of sensing units, the sensing units being disposed in a first direction and a second direction to form an array, wherein the sensing units are capacitive type, and capacitance values of the sensing units are gradually decreased along the first direction; and
a touch sensing module coupled to the touch sensing plate for sensing at least two real touch points.

2. The capacitive touch panel as claimed in claim 1, wherein the capacitance values of the sensing units are consistent along the second direction.

3. The capacitive touch panel as claimed in claim 1, when four system-determined touch points are detected, the sensing units are sensed along the second direction to sequentially sense a first duty cycle and a second duty cycle, and then the two real touch points are obtained from the four system-determined touch points according to the first duty cycle and the second duty cycle.

4. The capacitive touch panel as claimed in claim 3, wherein the touch sensing module comprises:
a plurality of pulse width modulation (PWM) signal generators respectively coupled to the sensing units, when the two real touch points are located at a first sensing unit and a second sensing unit of the sensing units, the first sensing unit and the second sensing unit are respectively corresponding to a first PWM signal generator and a second PWM signal generator of the PWM signal generators, and the first PWM signal generator and the second PWM signal generator are sequentially arranged along the second direction, the first PWM signal generator outputting a corresponding first PWM signal and then the second PWM signal generator outputting a corresponding second PWM signal, wherein duty cycles of the first PWM signal and the second PWM signal are respectively determined according to capacitance values of the first sensing unit and the second sensing unit; and
a touch point determination module coupled to the PWM signal generators, sequentially receiving the first PWM signal and the second PWM signal, and obtaining the two real touch points from the four system-determined touch points according to the duty cycles of the first PWM signal and the second PWM signal.

5. The capacitive touch panel as claimed in claim 3, wherein the four system-determined touch points form a rectangle, the four system-determined touch points are respectively a first system-determined touch point, a second system-determined touch point, a third system-determined touch point, and a fourth system-determined touch point, the first system-determined touch point and the fourth system-determined touch point are located at corners of a diagonal in respect of the rectangle, the second system-determined touch point and the third system-determined touch point are located at corners of the other diagonal in respect of the rectangle; when the first system-determined touch point gets closer to the fourth system-determined touch point by moving along the first direction or the second direction, the first system-determined touch point and the four system-determined touch point are the two real touch points when the first duty cycle is larger than the second duty cycle, or the second system-determined touch point and the third system-determined touch point are the two real touch points when the first duty cycle is smaller than the second duty cycle.

6. The capacitive touch panel as claimed in claim 1, wherein the first direction is perpendicular to the second direction.

7. The capacitive touch panel as claimed in claim 6, wherein the first direction is defined as a horizontal axis and the second direction is defined as a vertical axis.

8. The capacitive touch panel as claimed in claim 6, wherein the first direction is defined as a vertical axis and the second direction is defined as a horizontal axis.

9. The capacitive touch panel as claimed in claim 1, wherein capacitance values of the sensing units located at the two real touch point are increased.

10. A ghost point determination method, used in a capacitive touch panel comprising a touch sensing plate and a touch sensing module, wherein the touch sensing plate comprising a plurality of sensing units, the sensing units are disposed along a first direction and a second direction to form an array, the first direction is perpendicular to the second direction, the sensing units are capacitive type, and capacitance values of the sensing units are gradually decreased along the first direction, the ghost point determination method comprising:
sequentially sensing the sensing units along the second direction to sequentially sense a first duty cycle and a second duty cycle when four system-determined touch points are detected; and
obtaining two real touch points from the four system-determined touch points according to the first duty cycle and the second duty cycle.
